(19) United States
(12) Patent Application Publication
(10) Pub. No.: US 2016/0378853 A1
(43) Pub. Date: Dec. 29, 2016

(54) SYSTEMS AND METHODS FOR REDUCING SEARCH-ABILITY OF PROBLEM STATEMENT TEXT

(71) Applicant: Authess, Inc., Boston, MA (US)

(72) Inventor: Ali H. Mohammad, Cambridge, MA (US)

(21) Appl. No.: 15/192,271

(22) Filed: Jun. 24, 2016

Related U.S. Application Data
(60) Provisional application No. 62/185,226, filed on Jun. 26, 2015.

(51) Int. Cl. G06F 17/30

(52) U.S. Cl. CPC G06F 17/30684; G06F 17/30707; G06F 17/30864

(57) ABSTRACT

Reducing search-ability of text-based problem statements. An input text representing a problem statement using context phrases and content-bearing phrases, and having a first level of search-ability, is converted to one or more variants representing the same problem statement but with reduced search-ability. A search for one of the variants is unlikely to return the original problem statement, or any of the other variants. An ontology is used that specifies a set of keywords related to the problem statement, associates each keyword with a respective language property definition and a respective equivalence class, and indicates a subset of the set of keywords as non-replaceable keywords. A language processor uses the ontology to parse the input text and generate one or more variations.

### CROSS-REFERENCE TO RELATED PATENT APPLICATIONS

This application is a non-provisional utility application claiming priority to U.S. Provisional Application No. 62/185,226, titled “Making Homework Prompts Unfindable,” filed on Jun. 26, 2015, the entirety of which is incorporated herein by reference.

### BACKGROUND

Educators, teachers, professors, and the like distribute homework and take-home examination questions to students. It can take a significant amount of time and effort to draft these questions; accordingly, educators often prefer to reuse them. However, it is increasingly common for students to post the text of the questions to public forums, e.g., websites accessible via the Internet. Once a question is posted in a public space, it is often indexed by one or more search authorities and quickly becomes readily findable. As a result, a student can use these search authorities to quickly find the text of homework and examination questions that have been previously used. The student is then likely to also find answers or previously prepared responses. This can shortchange the educational process, and may sometimes lead to cheating or other undesirable results.

### SUMMARY OF THE INVENTION

Aspects and embodiments of the present disclosure are directed to systems and methods for generating rewritten text representations of a problem statement. A single input text can be converted into an extensive number of variations, each variation still representing the original problem statement. Each rewritten variation of the input text conveys the problem statement in a unique format, making it difficult (if not impossible) for someone to locate previous iterations in public forums. Further, because each rewritten version may be used by a smaller number of people, the opportunities for publication are reduced. This can ameliorate some of the difficulties with providing homework or take-home examination prompts.

In at least one aspect, the disclosure pertains to a system for reducing search-ability of text-based problem statements. The system includes an interface, a text classifier, and a text generator. The interface is configured to receive an input text representing a problem statement using context phrases and content-bearing phrases, the input text having a first level of search-ability. The text classifier identifies, for the input text, an ontology specifying a set of keywords related to the problem statement, the ontology associating each keyword with a respective language property definition and a respective equivalence class, and the ontology classifying a subset of the set of keywords as non-replaceable keywords. The text classifier identifies the context phrases in the input text using a statistical language model and, based on the ontology, a replaceable term in the input text. The text generator selects a substitute context passage for the identified context phrases and a substitute term for the identified replaceable term. The text generator generates an output text using the selected substitute context passage and the substitute term, the output text representing the problem statement and having a second level of search-ability lower than the first level of search-ability.

In some implementations of the system, the text generator selects the substitute context passage from a third-party publicly-accessible content source. In some implementations, the text generator identifies the third-party publicly-accessible content source based on a result of submitting at least a portion of the context phrases to a third-party search engine.

In some implementations of the system, the interface is configured to receive the ontology. In some such implementations, the interface receives an identifier for the ontology distinguishing the ontology from a plurality of candidate ontologies. In some implementations, the ontology defines a value range for the identified replaceable term, and the text generator selects the substitute term for the identified replaceable term within the defined value range. In some implementations, selects the substitute term for the identified replaceable term based on an equivalence class for the substitute term specified in the ontology.

In some implementations of the system, the text classifier identifies, based on the ontology, the replaceable term in the input text by confirming that the replaceable term is not classified in the ontology as a non-replaceable keyword.

In at least one aspect, the disclosure pertains to a method for reducing search-ability of text-based problem statements. The method includes receiving, by an interface, an input text representing a problem statement using context phrases and content-bearing phrases, the input text having a first level of search-ability. The method includes identifying, for the input text, an ontology specifying a set of keywords related to the problem statement, the ontology associating each keyword with a respective language property definition and a respective equivalence class, and the ontology classifying a subset of the set of keywords as non-replaceable keywords. The method includes identifying, by a text classifier, the context phrases in the input text using a statistical language model. The method includes identifying, by the text classifier, based on the ontology, a replaceable term in the input text. The method includes selecting a substitute context passage for the identified context phrases and selecting a substitute term for the identified replaceable term. The method includes generating an output text using the selected substitute context passage and the substitute term, the output text representing the problem statement and having a second level of search-ability lower than the first level of search-ability.

In at least one aspect, the disclosure pertains to a non-transitory computer-readable medium storing instructions that, when executed by a processor, cause the processor to receive an input text representing a problem statement using context phrases and content-bearing phrases, the input text having a first level of search-ability; identify, for the input text, an ontology specifying a set of keywords related to the problem statement, the ontology associating each keyword with a respective language property definition and a respective equivalence class, and the ontology classifying a subset of the set of keywords as non-replaceable keywords; identify the context phrases in the input text using a statistical language model; select a substitute context passage for the identified context phrases; identify, based on the ontology, a replaceable term in the input text; select a substitute term for the identified replaceable term; and generate an output text using the selected substitute context passage and the substitute term, the output text representing the problem statement and having a second level of search-ability lower than the first level of search-ability.

### BRIEF DESCRIPTION OF THE DRAWINGS

The above and related objects, features, and advantages of the present disclosure will be more fully understood by reference to the following detailed description, when taken in conjunction with the following figures, wherein:

FIG. 1 is a block diagram of an illustrative computing environment according to some implementations;

FIG. 2 is a flowchart for a method of reducing search-ability of text based problem statements;

FIG. 3 is a flowchart for a method of rewriting an input text based on an ontology; and

FIG. 4 is a block diagram illustrating a general architecture of a computing system suitable for use in some implementations described herein.

The accompanying drawings are not intended to be drawn to scale. Like reference numbers and designations in the various drawings indicate like elements. For purposes of clarity, not every component may be labeled in every drawing.

### DETAILED DESCRIPTION

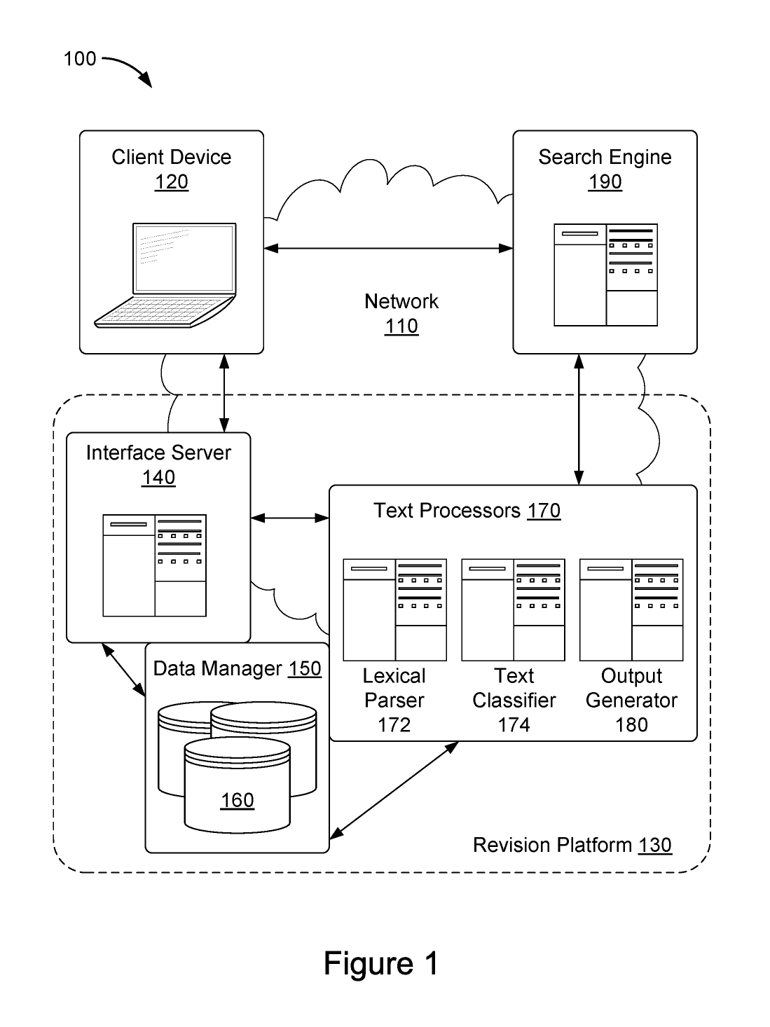

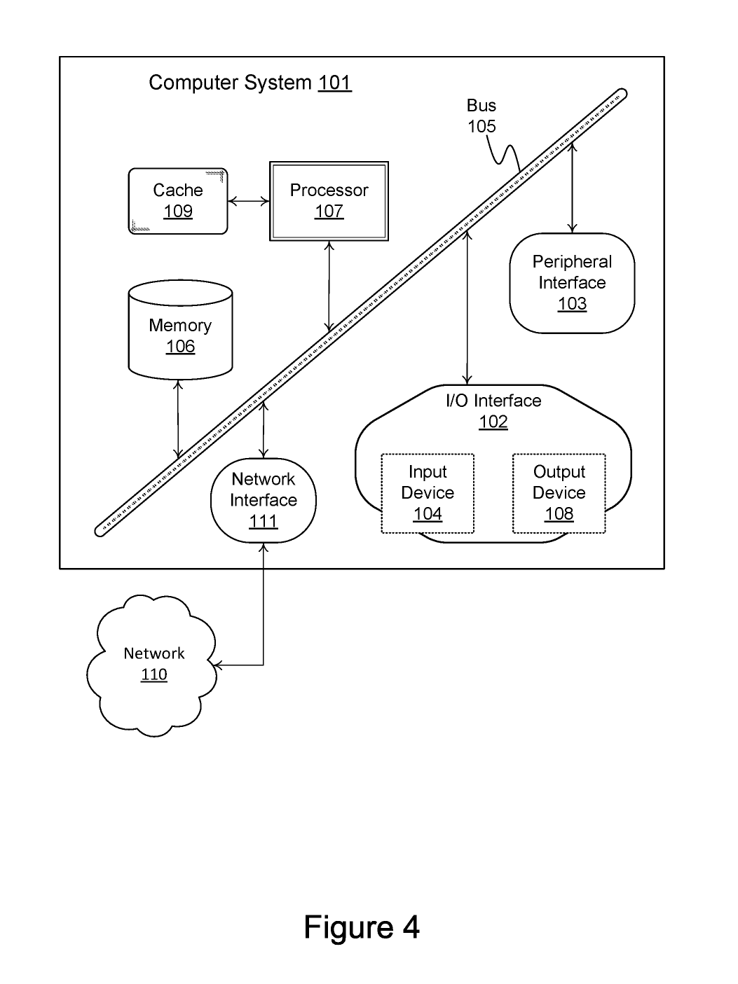

FIG. 1 is a block diagram of an illustrative computing environment 100. In brief overview of FIG. 1, the computing environment 100 includes a network 110 through which one or more client devices 120 communicate with a revision platform 130 via an interface server 140. The network 110 is a communication network, e.g., a data communication network such as the Internet. The revision platform 130 includes the interface server 140, a data manager 150 managing data on one or more storage devices 160, and one or more text processors 170. The text processors 170 include, for example, a lexical parser 172, a text classifier 174, and an output generator 180. The computing environment 100 further includes a search engine 190, which the client device 120 can use to conduct content searches via the network 110. In some implementations, the search engine 190 is operated by a third-party, distinct from the revision platform 130. Some elements shown in FIG. 1, e.g., the client devices 120, the interface server 140, and the various text processors 170, are computing devices such as the computer system 101 illustrated in FIG. 4 and described in more detail below.

Referring to FIG. 1 in more detail, the client device 120 is a computing device capable of text presentation and network communication. In some implementations, the client device 120 is a workstation, desktop computer, laptop or notebook computer, server, handheld computer, mobile telephone or other portable tele-communication device, media playing device, gaming system, mobile computing device, or any other type of computing system 101 illustrated in FIG. 4 and described in more detail below. In some implementations, the client device 120 includes a network interface for requesting and receiving a rewritten text via the network 110.

The network 110 is a data communication network, e.g., the Internet. The network 110 may be composed of multiple networks, which may each be any of a local-area network (LAN), such as a corporate intranet, a metropolitan area network (MAN), a wide area network (WAN), an inter network such as the Internet, or a peer-to-peer network, e.g., an ad hoc WiFi peer-to-peer network. The data links between devices may be any combination of wired links (e.g., fiber optic, mesh, coaxial, twisted-pair such as Cat-5, etc.) and/or wireless links (e.g., radio, satellite, or microwave based). The network 110 may include public, private, or any combination of public and private networks. The network 110 may be any type and/or form of data network and/or communication network. In some implementations, data flows through the network 110 from a source node to a destination node as a flow of data packets, e.g., in the form of data packets in accordance with the Open Systems Interconnection (“OSI”) layers, e.g., using an Internet Protocol (IP) such as IPv4 or IPv6. A flow of packets may use, for example, an OSI layer-4 transport protocol such as the User Datagram Protocol (UDP), the Transmission Control Protocol (“TCP”), or the Stream Control Transmission Protocol (“SCTP”), transmitted via the network 110 layered over IP.

The revision platform 130 includes the interface server 140, a data manager 150 managing data on one or more storage devices 160, and one or more text processors 170. The text processors 170 include, for example, a lexical parser 172, a text classifier 174, and an output generator 180. In some implementations, the lexical parser 172, text classifier 174, and/or the output generator 180 are implemented on the same, or shared, computing hardware.

The interface server 140 is a computing device, e.g., the computing system 101 illustrated in FIG. 4, that acts as an interface to the revision platform 130. The interface server 140 includes a network interface for receiving requests via the network 110 and providing responses to the requests, e.g., rewritten text generated by the output generator 180. In some implementations, the interface server 140 is, or includes, an input analyzer.

In some implementations, the interface server 140 provides an interface to the client device 120 in the form of a webpage, e.g., using the HyperText Markup Language (“HTML”) and optional webpage enhancements such as Flash, Javascript, and AJAX. The client device 120 executes a client-side browser or software application to display the webpage. In some implementations, the interface server 140 hosts the webpage. The webpage may be one of a collection of webpages, referred to in the aggregate as a website. In some implementations, the interface server 140 hosts a web server. In some implementations, the interface server 140 hosts an e-mail server conforming to the simple mail transfer protocol (SMTP) for receiving incoming e-mail. In some such implementations, a client device 120 interacts with the revision platform 130 by sending and receiving e-mails. E-mails may be sent or received via additional network elements, e.g., a third-party e-mail server (not shown). In some implementations, the interface server 140 implements an application programming interface (API) and a client device 120 can interact with the interface server 140 using custom API calls. In some implementations, the client device 120 executes a custom application to present an interface on the client device 120 that facilitates interaction with the interface server 140, e.g., using the API or a custom network protocol. In some implementations, the custom application executing at the client device 120 performs some of the text analysis described herein as performed by the text processors 170. In some implementations, the interface server 140 uses data held by the data manager 150 to provide the interface. For example, in some implementations, the interface includes webpage elements stored by the data manager 150.

The data manager 150 is a computer-accessible data management system for use by the interface server 140 and the text processors 170. The data manager 150 stores data in memory 160. In some implementations, the data manager 150 stores computer-executable instructions. In some implementations, the memory 160 stores a catalog of ontologies. In some implementations, the interface server 140 receives a request that specifies an ontology stored in the catalog. An ontology is a formal definition of terminology. An ontology can specify, for example, a naming scheme for a terminology. An ontology can specify various terms that may be used, types and properties associated with the terms, and interrelationships between terms. In some implementations, the catalog is divided into sections, e.g., by field of study (mathematics, biology, language studies, etc.). In some implementations, the interface server 140 facilitates searching the catalog. In some implementations, the catalog is stored in memory 160 as a database, e.g., a relational database, managed by a database management system (“DBMS”). In some implementations, the interface server 140 includes account management utilities. Account information and credentials are stored by the data manager 150, e.g., in the memory 160.

The memory 160 may each be implemented using one or more data storage devices. The data storage devices may be any memory device suitable for storing computer readable data. The data storage devices may include a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or BLU-RAY discs). Example implementations of suitable data storage devices include storage area networks (“SAN”), network attached storage (“NAS”), and redundant storage arrays.

The lexical parser 172 is illustrated as a computing device, e.g., the computing system 101 illustrated in FIG. 4. In some implementations, the lexical parser 172 is implemented with logical circuitry to parse input text into one or more data structures. In some implementations, the lexical parser 172 generates a parse tree. In some implementations, the lexical parser 172 generates a set of tokens or token sequences, each token representing a word or phrase. In some implementations, the lexical parser 172 is implemented as a software module. In some implementations, the lexical parser 172 uses a grammar or an ontology, e.g., to recognize a multi-word phrase as a single token. In some implementations, the lexical parser 172 includes a regular expression engine. In some implementations, the lexical parser 172 segments a text based on defined boundary conditions, e.g., punctuation or white-space. In some implementations the lexical parser 172 includes parts-of-speech tagging functionality, which uses language models to assign tags or grammar-classification labels to tokens. In some implementations, parts-of-speech tagging is handled separately, e.g., by a text classifier 174.

The text classifier 174 is illustrated as a computing device, e.g., the computing system 101 illustrated in FIG. 4. In some implementations, the text classifier 174 is implemented with logical circuitry to classify or categorize language tokens. In some implementations, the text classifier 174 is implemented as a software module. The text classifier 174 takes language tokens, or sequences of language tokens, and classifies the tokens (or sequences) based on language models, ontologies, grammars, and the like. In some implementations, the text classifier 174 identifies named entities, e.g., using a named-entity extraction tool. In some implementations, the text classifier 174 applies a grammar-classification label to each token, where the grammar-classification label specifies how the token fits a particular language model or grammar. For example, in some implementations, the text classifier 174 classifies tokens as nouns, verbs, adjectives, adverbs, or other parts-of-speech. In some implementations, the text classifier 174 determines whether a token represents a term that can be substituted with a value from a range of values. For example, the ontology may specify valid value ranges for certain terms (e.g., a specified hour can be between one and twelve or between one and twenty-four, rephrased as “noon” or “midnight,” or even generalized to morning, afternoon, or evening).

In some implementations, the text classifier 174 identifies content, text blocks, sentences, or token sequences as context language or as content-bearing language. For example, in some implementations, the text classifier 174 uses a statistical model to evaluate a phrase and classify the evaluated phrase as more or less likely to be content-bearing. Context language provides background information (or “color”) for a problem statement and can generally be removed without loss of representation of the problem statement itself. Accordingly, in some implementations, the text classifier 174 replaces a set of tokens corresponding to a context passage with a single token representing a generalized context. The context token may include information associating the generalized context with a particular subject matter such that a new context passage can be later generated corresponding to the same subject matter.

The output generator 180 is illustrated as a computing device, e.g., the computing system 101 illustrated in FIG. 4. In some implementations, the output generator 180 is implemented with logical circuitry to combine language into an output text. In some implementations, the output generator 180 is implemented as a software module. In some implementations, the output generator 180 is further configured to communicate, via the network 110, with one or more search engines 190 to validate the search-ability of an output text. The output generator 180 combines input from the lexical parser 172, text classifier 174, and any other text processors 170 to form a new output text that represents the same underlying problem statement as an input text received by the text processors 170. In some implementations, the output generator 180 re-orders words or tokens to modify a phrase structure. For example, the output generator 180 can convert a phrase from an active voice to a passive voice, or vice versa. In some implementations, the output generator 180 adjusts a phrase into an alternative phrase structure. Phase structure options include, but are not limited to, active voice, passive voice, an inverted phrase, a cleft phrase, or a command phrase. In some implementations, the output generator 180 uses a tree transducer to convert a phrase from one structure to another.

In some implementations, the output generator 180 validates that the output text conforms to language criteria. In some implementations, the output generator 180 uses one or more templates stored in memory 160. In some implementations, the output generator 180 provides a draft output text to the interface server 140 and receives feedback, e.g., feedback from a client device 120 through the interface server 140.

The search engine 190 is a computing device, e.g., the computing system 101 illustrated in FIG. 4. The search engine 190 is operated by a search authority to index public resources and provide a query interface for searching the indexed public resources. In some instances, the search engine 190 is operated by a third-party, separate and distinct from the operator of the revision platform 130. The search engine 190 may host publicly accessible content, e.g., hosting forums, webpages, chat servers, and the like. In some implementations, the client device 120 can submit a query to the search engine 190, via the network 110, and obtain search results from the search engine 190 (or from another server at the behest of the search engine 190). The search results may identify resources hosted by the search engine 190 or by additional network-accessible servers not shown. In some implementations, the search authority 190 indexes publicly accessible content by accessing network servers with software referred to as spiders or crawlers. The indexing software obtains content from the network servers and identifies keywords in the content, which can then be used to select the content for inclusion in a search result. In some implementations, content is ranked for inclusion in a search result based on relevance to a query, popularity with other webpages (cross linking), and other ranking criteria that may be used. In general, the most popular and well regarded pages peppered with keywords related to a query term will be returned by a search engine 190 in search results for a query that includes the query term. To prevent a text from appearing in these search results, it can be helpful to phrase the text with language that misdirects the search authority to popular, but irrelevant, destinations while avoiding inclusion of keywords that would bring up a related core text, e.g., an original version of a revised text. A text that, when searched for using the text or portions of the text, returns search results that include the text (or highly related text) is considered to be “search-able.” A text is more search-able if search results feature the original text (or highly related text) in the top ranked results, e.g., on the first page or first n pages of search results returned from the search engine 190 responsive to a search for the text or portions of the text. An input text to the revision platform 130 is highly related to the output text, so a search for the output text that returns search results featuring the input text would make the output text highly search-able even if the output text itself isn't featured in the search results.

The revision platform 130 accepts, via the interface server 140, an input text and generates an output text using the output generator 180. In some implementations, the output text is non-deterministic, meaning that repeatedly submitting the same input text should yield different output texts each time. Variations in substitute context language, replacement keywords, and range value selections can result in tens, hundreds, thousands, or hundreds of thousands of possible output texts for a single input text. Each output text is constructed to make searching for language in the output text ineffective in finding the original input text or any of the other variant output texts. However, despite the unique characteristics of each output text, each output text will still represent the same core problem as the input text. An educator can draft a single problem statement and use the revision platform 130 to generate a unique variation of the problem for each class, or even for each student in a class. By reducing search-ability of the original text-based problem statement in this manner, the problem statements distributed to the students will, from the perspective of the students, be effectively new even if the original input text has been used for multiple classes. In some implementations, an analytics tool assigns a score to each text based on a search-ability of the text. As described in more detail herein, the score may be higher if a search for a text, or a portion of a text, yields search results that include the text, that include the text in a high ranking position (e.g., on the first page, or first n pages, of search results), or that includes a related text (e.g., a search for an output text that returns the input text is not desirable and would be assigned a high search-ability score).

The input text represents a problem statement. The text includes context phrases and content-bearing phrases. The content-bearing phrases are formed from words, named entities, including replaceable words, non-replaceable keywords, and various other nouns, verbs, adjectives, adverbs, and so forth. The input text has a first level of search-ability. To reduce the search-ability to a lower second level, the text processors 170 identify the component parts of the input text and generate substitutes. For example, the input text might begin with a context sentence followed by a sentence or two that include named entities such as a person, place, or specific thing. The resulting output text may replace the original context sentence with a generic context sentence that, when searched, acts as a red herring burying more relevant search results under a sea of unrelated search results. The resulting output text might include different names for the named entities, e.g., replacing “Jamie” with “Pat.” The resulting output text might replace words with synonyms, e.g., replacing “carnival” with “festival” or “fair.” The ordering of language can be altered, too. For example, the sentence “Brian drove Sarah to the store in his car” might be rephrased “Using her car, Ruth drove Jesse to the mall.” The rephrased sentence conveys the same information, that two people drove somewhere, but a search for one phrase is unlikely to find the other.

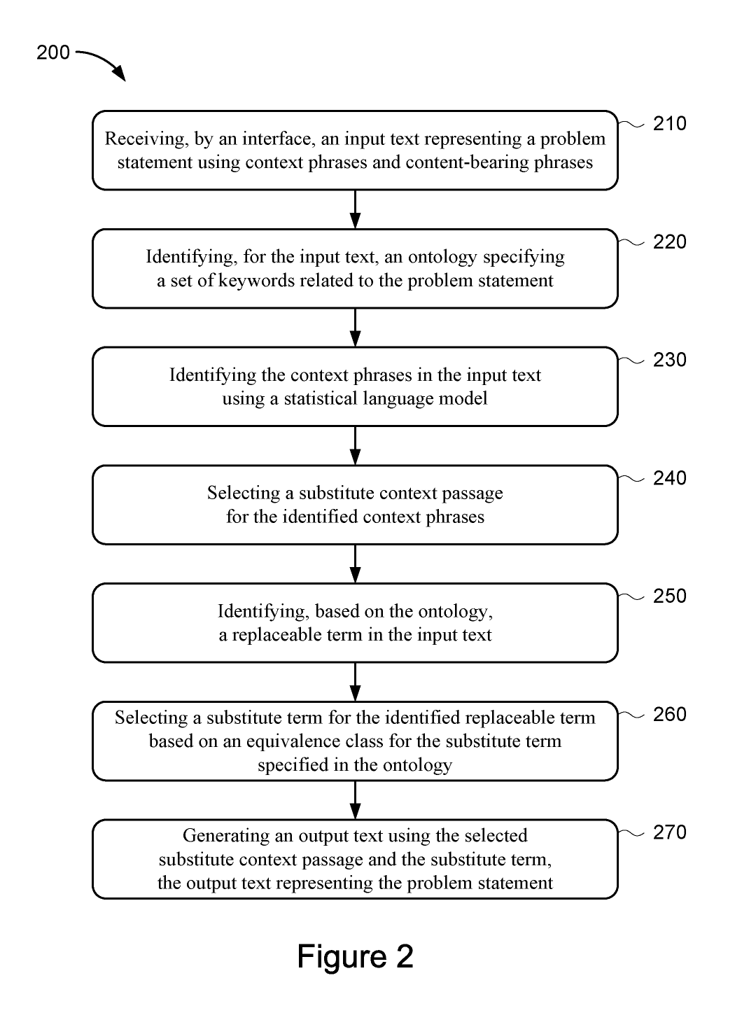

FIG. 2 is a flowchart for a method 200 of reducing search-ability of text-based problem statements. In broad overview, at stage 210, the interface server 140 receives an input text representing a problem statement from a client device 120. The input text represents the problem statement using context phrases and content-bearing phrases. At stage 220, an ontology is identified for the input text specifying a set of keywords related to the problem statement. At stage 230, the text classifier 174 identifies the context phrases in the input text using a statistical language model. At stage 240, the output generator 180 selects a substitute context passage for the identified context phrases. At stage 250, the text classifier identifies, based on the ontology, a replaceable term in the input text. At stage 260, the output generator 180 selects a substitute term for the identified replaceable term based on an equivalence class for the substitute term specified in the ontology. At stage 270, the output generator 180 generates an output text using the selected substitute context passage and the substitute term, the output text representing the problem statement. The interface server 140 can then return the output text to the client device 120 responsive to the input text received from the client device 120.

Referring to FIG. 2 in more detail, at stage 210, the interface server 140 receives an input text representing a problem statement from a client device 120. The input text represents the problem statement using context phrases and content-bearing phrases. In some implementations, the interface server 140 provides an interface to a client device 120, e.g., a webpage or custom application, and receives the input text via the provided interface. In some implementations, the interface server 140 maintains an e-mail inbox, and the interface server 140 processes content included or attached to incoming e-mails. In some implementations, the interface server 140 receives additional information or criteria along with the input text. In some implementations, the interface server 140 uses the data manager 150 to store the input text in memory 160. In some implementations, the interface server 140 passes the input text, or an identifier associated with stored input text, to a text processor 170, e.g., the lexical parser 172.

In some implementations, the text processors 170 include an analytics tool that assigns a score to the input text based on a search-ability of the input text. In some implementations, the analytics tool passes the input text, or portions of the input text, to one or more search engines 190 and determines a relevancy of corresponding search results to the input text. If the input text is found, verbatim or near-verbatim, by any of the search engines 190, the analytics tool would assign a high search-ability score to the input text. If the search results are highly relevant to the input text, e.g., containing a description of the input text or explanations of distinguishing sentences within the input text, the analytics tool would assign a search-ability score to the input text that is lower than the score for a verbatim result, but still relatively high. A lower score is assigned if the search results are unrelated to the input text. In some implementations, the analytics tool predicts search-ability based on the input text itself. For example, if the input text includes distinct phrases with a low probability of occurrence according to a language model or Markov model, the text may have a higher search-ability score even if search results currently return less relevant results. Likewise, if the input text includes distinct phrases that return no search results from the search engines 190, the input text may be assigned a high search-ability score because the text, if indexed by a search engine 190, would be easily found based on the distinct phrase. The score represents a level of search-ability.

At stage 220, an ontology is identified for the input text specifying a set of keywords related to the problem statement. In some implementations, the ontology specifies a set of keywords related to the problem statement. In some implementations, the ontology associates each keyword with a respective language property definition and a respective equivalence class. In some implementations, the ontology specifies a set of keywords (or a subset of keywords) as non-replaceable keywords. In some implementations, the ontology specifies a set of keywords (or a subset of keywords) as entity names. In some implementations, a text processors 170 identifies an ontology, e.g., from a catalog of ontologies stored by the data manager 150. For example, in some implementations, the text classifier 174 identifies a subject matter related to the input text and selects an ontology related to the identified subject matter. In some implementations, the interface server 140 identifies the ontology. For example, in some implementations, the interface server 140 receives the ontology from the client device 120, or receives a selection of an ontology from the client device 120 (e.g., receiving a selection from the catalog).

At stage 230, the text classifier 174 identifies the context phrases in the input text using a statistical language model. Context language provides background information (or “color”) for a problem statement and can generally be removed without loss of representation of the problem statement itself. The text classifier 174 uses the statistical language model to assign a probability score to each phrase weighing the likelihood that a phrase is context or content-bearing. In some implementations, the text classifier 174, via the interface server 140, sends a sample of identified context phrases to the client device 120 for confirmation. Feedback from the client device 120 is then used to improve the quality of the probability scores. In some implementations, the text classifier 174 uses a learning machine to incorporate feedback. In some implementations, the text classifier 174 identifies a particular subject matter of the context phrases, e.g., based on relevancy of the phrases to the particular subject matter, or relevancy of the input text to the particular subject matter.

At stage 240, the output generator 180 selects a substitute context passage for the identified context phrases. In some implementations, the output generator 180 selects the substitute context passage from a set of templates stored by the data manager 150. In some implementations, the output generator 180 selects the substitute context passage from a third-party resource, e.g., a public data repository. For example, in some implementations, the output generator 180 submits a search query to a search engine 190 and uses a result of the search to generate the substitute context passage. In some implementations, the substitute context passage is the first few sentences of an article in a public knowledge base related to the particular subject matter.

At stage 250, the text classifier 174 identifies, based on the ontology, a replaceable term in the input text. The text classifier 174 compares terms to terms defined or specified in the ontology. In some implementations, if a term is not in a set of non-replaceable keywords indicated by the ontology, then it is replaceable. In some implementations, the ontology identifies specific replaceable terms.

At stage 260, the output generator 180 selects a substitute term for the identified replaceable term based on an equivalence class for the substitute term specified in the ontology. In some implementations, the substitute term is a synonym for the term to be replaced. In some implementations, the equivalence class defines a list of acceptable substitutes and the output generator 180 selects one at random. The equivalence class may be specific to a particular subject matter. For example, ‘cat’ and ‘trunk’ may be sufficiently equivalent for a physics problem but not for a zoology problem. When a term is replaced, the output generator 180 makes the same replacement for all incidents of the term in the input text.

At stage 270, the output generator 180 generates an output text using the selected substitute context passage and the substitute term, the output text representing the problem statement. In some implementations, the output generator 180 populates a template, e.g., a template stored in memory 160 or selected by the interface 140. In some implementations, the output generator 180 combines the context passage selected at stage 240 with the original content-bearing phrases, replacing terms in the result with substitute terms selected at stage 260. In some implementations, the output generator 180 alters the sequence of terms in some sentences, restructuring phrasing of the sentence. For example, the output generator 180 may convert a sentence from active voice to passive voice, or vice versa. In some implementations, the output generator 180 converts a phrase into an alternative phrase structure. Phase structure options include, but are not limited to, active voice, passive voice, an inverted phrase, a cleft phrase, or a command phrase. A cleft phrase is one that subordinates an action below an object of the action, typically beginning with the word “it.” As an example, the sentence “The student is searching for the homework solution” may be converted to the cleft form, “It's the homework solution the student is searching for.” In some implementations, the output generator 180 uses a tree transducer to convert a phrase from one structure to another.

In some implementations, the revision platform 130 validates that the output text is less searchable than the input text. For example, in some implementations, the output generator 180 submits a query to a search engine 190 and evaluates the results. In some implementations, the output generator 180 submits multiple queries to the search engine 190 based on the input text and the generated output text, and compares relevancy of the results from the multiple queries. In some implementations, if search results based on the generated output text include results related to the input text, the output text is discarded and the method 300 is repeated.

The interface server 140 can then return the output text to the client device 120 responsive to the input text received from the client device 120. In some implementations, a client device 120 may submit a request for multiple variations of a single input text and the multiple variations are returned responsive to the single request submission.

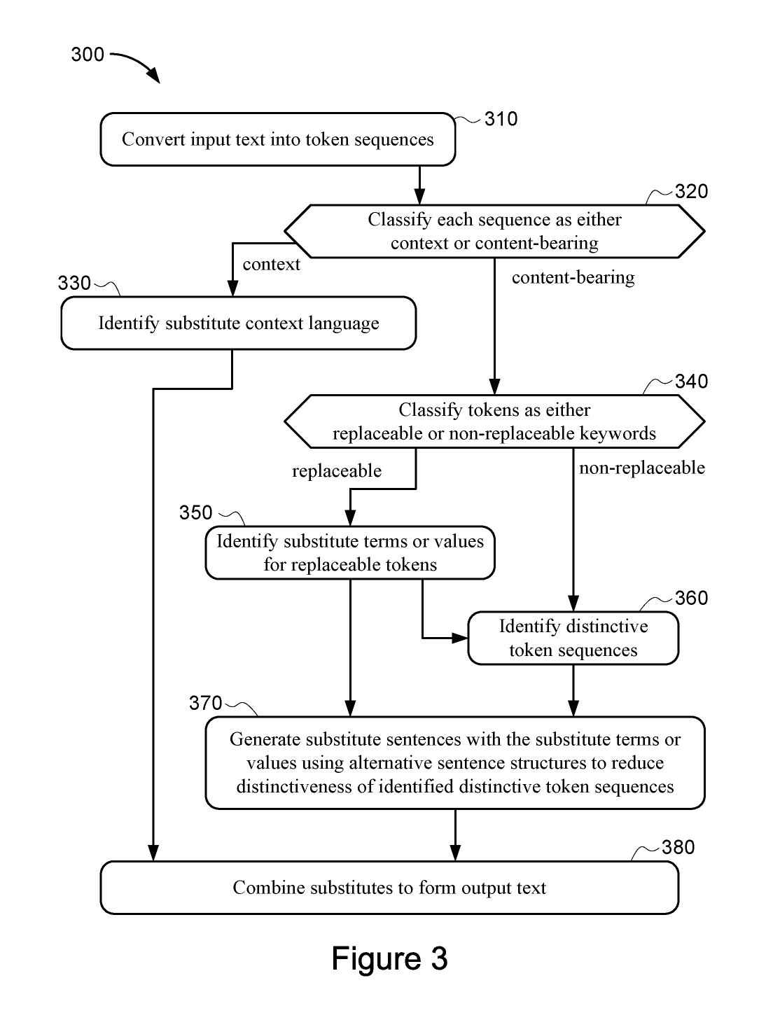

FIG. 3 is a flowchart for a method 300 of rewriting an input text based on an ontology. In broad overview, at stage 310, a text processor 170 converts an input text into token sequences. At stage 320, the text processor 170 classifies each sequence as either context or content bearing. At stage 330, the text processor 170 identifies substitute context language for the sequences identified in stage 320 as contextual. At stage 340, the text processor 170 further classifies tokens from content-bearing sequences as either replaceable or non-replaceable. At stage 350, the text processor 170 identifies substitute terms or values for replaceable tokens. At stage 360, the text processor 170 identifies distinctive token sequences. The distinctive token sequences may include non-replaceable keywords and replaceable or substitute terms. At stage 370, the text processor 170 generates substitute sentences with the substitute terms or values using alternative sentence structures to reduce distinctiveness of identified distinctive token sequences. Then, at stage 380, the text processor 170 combines the substitutes from stages 330, 350, and 360 to form an output text.

Referring to FIG. 3 in more detail, the stages described may be handled by a single text processor 170 or by a collection of the text processors 170 working in concert. In some implementations, a lexical parser 172, a text classifier 174, and an output generator 180 are used. In some implementations, additional language processing tools are used.

At stage 310, a text processor 170 converts an input text into token sequences. In some implementations, a lexical parser 172 converts the input text into token sequences. Each token represents a term or phrase found within the input text. A sequence of tokens corresponds to a sentence or phrase structure. In some implementations, the lexical parser 172 generates a parse tree, each leaf of the parse tree corresponding to a token and the nodes of the tree corresponding to a grammar-classification label such as a part-of-speech tag.

At stage 320, the text processor 170 classifies each sequence as either context or content bearing. In some implementations, context sequences are identified using a statistical model. In some implementations, the text processor 170 uses a natural language processor to identify which portions of an input text are most likely to be content bearing versus mere context. In some implementations, the text processor uses machine learning to improve the classification. In some implementations, the text processor 170 classifies a sample portion of the input text as either context or content bearing and submits the sample to the client device 120, via the interface server 140, for confirmation. The text processor 170 can then improves the quality of further classifications based on feedback received from the client device 120 responsive to the sample. In some implementations, multiple sample iterations are used.

At stage 330, the text processor 170 identifies substitute context language for the sequences identified in stage 320 as contextual. In some implementations, the substitute context language is sourced from a public resource. In some implementations, the memory 160 includes a variety of context passages suitable for various contexts. The text processor 170 selects a suitable context passage based on the subject matter of the input text. In some implementations, the text processor 170 selects the context passage based on substitute terms identified separately.

At stage 340, the text processor 170 further classifies tokens from content-bearing sequences as either replaceable or non-replaceable. In some implementations, the text processor 170 uses an ontology specifying a set of non-replaceable keywords. If a token corresponds to a specified non-replaceable keyword, the text processor 170 classifies it as non-replaceable. A token may correspond to a specified non-replaceable keyword if it shares the same root even if the conjugation differs from the specified non-replaceable keyword. In some implementations, a token may correspond to a specified non-replaceable keyword if it is a synonym for the keyword. In some implementations, a token is replaceable unless it corresponds to a non-replaceable keyword specified in the ontology.

At stage 350, the text processor 170 identifies substitute terms or values for replaceable tokens. In some implementations, replaceable tokens may include variables, named entities, a common terms. Terms that can be replaced with a range of values are variables. In some implementations, variables are populated at random. In some implementations, the interface server 140 queries the client device 120 for suggested replacement values. In some implementations, variables are specified in the ontology, along with a set or range of appropriate replacement values.

At stage 360, the text processor 170 identifies distinctive token sequences. The distinctive token sequences may include non-replaceable keywords and replaceable or substitute terms. In some implementations, distinctive token sequence is one in which tokens have a low probability of following precedent tokens. A Markov model is used to assess a probability that a particular sequence of tokens would occur. If that probability is below a threshold, the sequence is considered distinctive. The ordering may be changed, or the terms may be changed, or both, to achieve a higher probability and thus a lower distinctiveness.

At stage 370, the text processor 170 generates substitute sentences with the substitute terms or values using alternative sentence structures to reduce distinctiveness of identified distinctive token sequences. In some implementations, the text processor 170 fits the tokens to an alternative sentence structure, forming a sentence in active voice, passive voice, cleft form, or any other phrase structure.

At stage 380, the text processor 170 combines the substitutes from stages 330, 350, and 360 to form an output text. In some implementation, the substitutes are used to populate a template.

In view of the systems and methods described herein, an application or hosted service may be implemented, designed, or constructed to automatically transform text from an initial form into a less searchable alternative form that corresponds to the initial form in meaning, intent, or desired effect. Both the initial and the alternative forms of the text convey the same problem statement. However, a search for one form of the text is unlikely to return the other form. As a result, the problem statement becomes less “searchable.” In addition, in some implementations, the output text is designed to be difficult to search for, too. That is, even if the text were published to a webpage, search engines may have difficulty correlating a query for the text to the published instance of the same text. For example, in some implementations, the output text is seeded with common phrases or terminology that will cause a search engine to return a large number of “red herring” search results, effectively burying the published version. In some implementations, an analytics tool assigns a score to each text based on a search-ability of the text. In some implementations, the analytics tool passes the text, or portions of the text, to one or more search engines and determines a relevancy of corresponding search results to the text. A higher score corresponds to search results that are particularly relevant to the text, e.g., finding the text itself or subject matter specific to the problem statement represented by the text. A lower score corresponds to search results that are more general and less relevant to the specific text. In some implementations, the analytics tool predicts search-ability based on the text itself. For example, if the text includes distinct phrases, e.g., phrases with a low probability of occurrence according to a language model or Markov model, the text may have a higher search-ability score even if search results currently return less relevant results. This is because the text, if indexed by a search engine 190, would be easily found based on the distinct phrase.

The application or hosted service may be implemented using the revision platform 130 illustrated in FIG. 1. The interface server 140 can host an interface (e.g., a website or API for a custom client-side application) that enables a client device 120 to submit an input text and a request to generate one or more variations of the input text. The request can include or identify an ontology. In some implementations, the interface facilitates configuration selections or feedback from the client device 120 to further control the output generation. A user of the client device 120, e.g., an educator, teacher, professor, or examiner, can submit a text and obtain unique variations for distribution to students, test takers, candidates, or groups thereof. The input text may be a word problem such as a math or logic problem, an essay prompt, a programming task, a subject-specific question such as a biology, geology, chemistry, physics, or planetary sciences question. Because each iteration of the question is new and different, a user can reuse the same initial question year after year, test after test, homework assignment after homework assignment. This can represent a significant savings.

In some implementations, a publisher (e.g., a publisher of academic textbooks) may include “secret” questions in a book. In such implementations, the publisher submits a “secret” question to the revision platform 130 for storage in memory 160. The book then includes a problem identifier (e.g., a serial number, or a bar code or QR-code representing the serial number) but not the actual text of the “secret” question. A student (e.g., a reader or consumer of the book) then submits the problem identifier to the interface server 140 and receives, in response, a freshly generated variation of the “secret” question. Each time a student does this, a new variation of the problem is produced. Accordingly, a search for the resulting text will not yield the original “secret” question. In some such implementations, each book has a unique serial number so that the identifier itself cannot be searched. In some implementations, the book is published in digital form, e.g., as an EBOOK or as a webpage. When published in digital form, the problem identifier can be a link (e.g., a uniform resource locator (URL)) to the interface server 140. In some implementations, the link can uniquely identify the student or reader, e.g., by embedding or including user-specific information or credentials.

In some implementations, an application or hosted service using the systems and methods described above may automatically transform an electronic representation of a problem into a variant of the same problem meant to test the same skills as tested by the original problem. The specific words may have changed (e.g., substituting different nouns and verbs) but the underlying problem solving task remains the same. That is, the intent of the question remains unchanged even though the terminology and phrasing of the question has been modified.

Many word problems are unaffected by changing the names of entities in the problem. An arithmetic problem in which Andrew is counting apples is no different from a problem in which Martin is counting pears. A physics problem set atop an eleven story library is unlikely to be any different from a physics problem set atop an eleven story office tower. If the exact height of the building is unimportant to the problem, then the height becomes a variable. The location could then be a three story brownstone without changing the underlying problem. Modifications like these can be restricted by an ontology tailored to the problem subject matter.

As a brief example, consider the input text “An apple a day keeps the doctor away! Susan has 30 apples and 17 oranges. After she exchanges 15 apples for 2 oranges with John, how many pieces of fruit does she have?” The input text begins with the context phrase, “An apple a day keeps the doctor away!” The numbers (30, 17, 15, 2) are variable counts. The terms “apples” and “oranges” are variables classified as “fruit,” and the names “Susan” and “John” are variable names. The text processors would select new context statements and new values for these variables. For example, the text processors might replace the fruits “apples” and “oranges” with the gemstones “rubies” and “diamonds.” Having identified a new context and new variable names using an appropriate ontology, a possible output text responsive to this input text would be: “Croesus, a legendary King with enormous wealth, has 40,000 rubies and 10,000 diamonds. He buys 10,000 diamonds from Cyrus, but it costs him 35,000 rubies. How many gemstones does he have now?” Another possible output for this example input text would be: “The Bronx Zoo is the largest metropolitan zoo in the United States. The zoo has 17 spotted jackals and 4 striped jackals. An animal trader offers to give the zoo an additional 10 striped jackals in exchange for one of the spotted jackals. If the zoo took the trade, how many jackals would it have altogether?” Each of these text statements ask the same basic math problem, but otherwise appear unrelated. This makes it difficult to search for one problem based on another.

FIG. 4 is a block diagram illustrating a general architecture of a computing system 101 suitable for use in some implementations described herein The example computing system 101 includes one or more processors 107 in communication, via a bus 105, with one or more network interfaces 111 (in communication with a network 110), I/O interfaces 102 (for interacting with a user or administrator), and memory 106. The processor 107 incorporates, or is directly connected to, additional cache memory 109. In some uses, additional components are in communication with the computing system 101 via a peripheral interface 103. In some uses, such as in a server context, there is no I/O interface 102 or the I/O interface 102 is not used. In some uses, the I/O interface 102 supports an input device 104 and/or an output device 108. In some uses, the input device 104 and the output device 108 use the same hardware, for example, as in a touch screen. In some uses, the computing system 101 is stand-alone and does not interact with a network 110 and might not have a network interface 111.

The processor 107 may be any logic circuitry that processes instructions, e.g., instructions fetched from the memory 106 or cache 109. In many implementations, the processor 107 is a microprocessor unit. The processor 107 may be any processor capable of operating as described herein. The processor 107 may be a single core or multi-core processor. The processor 107 may be multiple processors. In some implementations, the processor 107 is augmented with a co-processor, e.g., a math co-processor or a graphics co-processor.

The I/O interface 102 may support a wide variety of devices. Examples of an input device 104 include a keyboard, mouse, touch or track pad, trackball, microphone, touch screen, or drawing tablet. Example of an output device 108 include a video display, touch screen, refreshable Braille display, speaker, inkjet printer, laser printer, or 3D printer. In some implementations, an input device 104 and/or output device 108 may function as a peripheral device connected via a peripheral interface 103.

A peripheral interface 103 supports connection of additional peripheral devices to the computing system 101. The peripheral devices may be connected physically, as in a universal serial bus (“USB”) device, or wirelessly, as in a BLUETOOTH™ device. Examples of peripherals include keyboards, pointing devices, display devices, audio devices, hubs, printers, media reading devices, storage devices, hardware accelerators, sound processors, graphics processors, antennas, signal receivers, measurement devices, and data conversion devices. In some uses, peripherals include a network interface and connect with the computing system 101 via the network 110 and the network interface 111. For example, a printing device may be a network accessible printer.

The network 110 is any network, e.g., as shown and described above in reference to FIG. 1. Examples of networks include a local area network (“LAN”), a wide area network (“WAN”), an inter-network (e.g., the Internet), and peer-to-peer networks (e.g., ad hoc peer-to-peer networks). The network 110 may be composed of multiple connected sub-networks and/or autonomous systems. Any type and/or form of data network and/or communication network can be used for the network 110.

The memory 106 may each be implemented using one or more data storage devices. The data storage devices may be any memory device suitable for storing computer readable data. The data storage devices may include a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or BLU-RAY discs). Example implementations of suitable data storage devices include storage area networks (“SAN”), network attached storage (“NAS”), and redundant storage arrays.

The cache 109 is a form of data storage device place on the same circuit strata as the processor 107 or in close proximity thereto. In some implementations, the cache 109 is a semiconductor memory device. The cache 109 may be include multiple layers of cache, e.g., L1, L2, and L3, where the first layer is closest to the processor 107 (e.g., on chip), and each subsequent layer is slightly further removed. Generally, cache 109 is a high-speed low-latency memory.

The computing system 101 can be any workstation, desktop computer, laptop or notebook computer, server, handheld computer, mobile telephone or other portable tele-communication device, media playing device, a gaming system, mobile computing device, or any other type and/or form of computing, telecommunications or media device that is capable of communication and that has sufficient processor power and memory capacity to perform the operations described herein. In some implementations, one or more devices are constructed to be similar to the computing system 101 of FIG. 4. In some implementations, multiple distinct devices interact to form, in the aggregate, a system similar to the computing system 101 of FIG. 4.

In some implementations, a server may be a virtual server, for example, a cloud-based server accessible via the network 110. A cloud-based server may be hosted by a third-party cloud service host. A server may be made up of multiple computer systems 101 sharing a location or distributed across multiple locations. The multiple computer systems 101 forming a server may communicate using the network 110. In some implementations, the multiple computer systems 101 forming a server communicate using a private network, e.g., a private backbone network distinct from a publicly-accessible network, or a virtual private network within a publicly-accessible network.

It should be understood that the systems and methods described above may be provided as instructions in one or more computer programs recorded on or in one or more articles of manufacture, e.g., computer-readable media. The article of manufacture may be a floppy disk, a hard disk, a CD-ROM, a flash memory card, a PROM, a RAM, a ROM, or a magnetic tape. In general, the computer programs may be implemented in any programming language, such as C, C++, C#, LISP, Perl, PROLOG, Python, Ruby, or in any byte code language such as JAVA. The software programs may be stored on or in one or more articles of manufacture as object code. The article of manufacture stores this data in a non-transitory form.

While this specification contains many specific implementation details, these descriptions are of features specific to various particular implementations and should not be construed as limiting. Certain features described in the context of separate implementations can also be implemented in a unified combination. Additionally, many features described in the context of a single implementation can also be implemented separately or in various sub-combinations. Similarly, while operations are depicted in the figures in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms. Likewise, references to “and/or” may be construed as an explicit use of the inclusive “or.” The labels “first,” “second,” “third,” an so forth are not necessarily meant to indicate an ordering and are generally used merely as labels to distinguish between like or similar items or elements.

Having described certain implementations and embodiments of methods and systems, it will now become apparent to one of skill in the art that other embodiments incorporating the concepts of the disclosure may be used. Therefore, the disclosure should not be limited to certain implementations or embodiments, but rather should be limited only by the spirit and scope of the following claims.

What is claimed:

1. A method of reducing search-ability of text-based problem statements, the method comprising:
receiving, by an interface, an input text representing a problem statement using context phrases and content-bearing phrases, the input text having a first level of search-ability;
identifying, for the input text, an ontology specifying a set of keywords related to the problem statement, the ontology associating each keyword with a respective language property definition and a respective equivalence class, and the ontology classifying a subset of the set of keywords as non-replaceable keywords;
identifying, by a text classifier, the context phrases in the input text using a statistical language model;
selecting a substitute context passage for the identified context phrases;
identifying, by the text classifier, based on the ontology, a replaceable term in the input text;
selecting a substitute term for the identified replaceable term; and
generating an output text using the selected substitute context passage and the substitute term, the output text representing the problem statement and having a second level of search-ability lower than the first level of search-ability.

2. The method of claim 1, the method comprising selecting the substitute context passage from a third-party publicly-accessible content source.

3. The method of claim 2, the method comprising identifying the third-party publicly-accessible content source based on a result of submitting at least a portion of the context phrases to a third-party search engine.

4. The method of claim 1, the method comprising receiving the ontology via the interface.

5. The method of claim 1, the method comprising receiving an identifier for the ontology via the interface, the identifier distinguishing the ontology from a plurality of candidate ontologies.

6. The method of claim 1, the method comprising identifying, by the text classifier, based on the ontology, the replaceable term in the input text by confirming that the replaceable term is not classified in the ontology as a non-replaceable keyword.

7. The method of claim 1, wherein the ontology defines a value range for the identified replaceable term, the method comprising selecting the substitute term for the identified replaceable term within the defined value range.

8. The method of claim 1, comprising selecting the substitute term for the identified replaceable term based on an equivalence class for the substitute term specified in the ontology.

9. A system for reducing search-ability of text-based problem statements, the system comprising:
an interface configured to receive an input text representing a problem statement using context phrases and content-bearing phrases, the input text having a first level of search-ability;
a text classifier comprising at least one processor configured to:
identify, for the input text, an ontology specifying a set of keywords related to the problem statement, the ontology associating each keyword with a respective language property definition and a respective equivalence class, and the ontology classifying a subset of the set of keywords as non-replaceable keywords;
identify the context phrases in the input text using a statistical language model;
identify, based on the ontology, a replaceable term in the input text; and
a text generator comprising at least one processor configured to:
select a substitute context passage for the identified context phrases;
select a substitute term for the identified replaceable term; and
generate an output text using the selected substitute context passage and the substitute term, the output text representing the problem statement and having a second level of search-ability lower than the first level of search-ability.

10. The system of claim 9, the text generator further configured to select the substitute context passage from a third-party publicly-accessible content source.

11. The system of claim 10, the text classifier further configured to identify the third-party publicly-accessible content source based on a result of submitting at least a portion of the context phrases to a third-party search engine.

12. The system of claim 9, the interface further configured to receive the ontology.

13. The system of claim 9, the interface further configured to receive an identifier for the ontology distinguishing the ontology from a plurality of candidate ontologies.

14. The system of claim 9, the text classifier further configured to identify, based on the ontology, the replaceable term in the input text by confirming that the replaceable term is not classified in the ontology as a non-replaceable keyword.

15. The system of claim 9, wherein the ontology defines a value range for the identified replaceable term, the text generator further configured to select the substitute term for the identified replaceable term within the defined value range.

16. The system of claim 9, the text generator further configured to select the substitute term for the identified replaceable term based on an equivalence class for the substitute term specified in the ontology.

17. A non-transitory computer-readable medium storing instructions that, when executed by a processor, cause the processor to:
receive an input text representing a problem statement using context phrases and content-bearing phrases, the input text having a first level of search-ability;
identify, for the input text, an ontology specifying a set of keywords related to the problem statement, the ontology associating each keyword with a respective language property definition and a respective equivalence class, and the ontology classifying a subset of the set of keywords as non-replaceable keywords;
identify the context phrases in the input text using a statistical language model;
select a substitute context passage for the identified context phrases;
identify, based on the ontology, a replaceable term in the input text;
select a substitute term for the identified replaceable term; and
generate an output text using the selected substitute context passage and the substitute term, the output text representing the problem statement and having a second level of search-ability lower than the first level of search-ability.

18. The non-transitory computer-readable medium of claim 17, wherein the instructions, when executed by the processor, cause the processor to select the substitute context passage from a third-party publicly-accessible content source.

19. The non-transitory computer-readable medium of claim 18, wherein the instructions, when executed by the processor, cause the processor to identify the third-party publicly-accessible content source based on a result of submitting at least a portion of the context phrases to a third-party search engine.

20. The non-transitory computer-readable medium of claim 17, wherein the instructions, when executed by the processor, cause the processor to select the substitute term for the identified replaceable term based on a defined value range or an equivalence class for the substitute term specified in the ontology.
